(19) United States
(12) Patent Application Publication
(10) Pub. No.: US 2026/0181717 A1
(43) Pub. Date: Jun. 25, 2026

(54) ENHANCEMENT MECHANISM FOR FINE TIME MEASUREMENT

(71) Applicant: Hewlett Packard Enterprise Development LP, Spring, TX (US)

(72) Inventors: Xiaoyang Fu, Beijing (CN); Xuguang Jia, Beijing (CN); Junpeng Wu, Beijing (CN)

(21) Appl. No.: 18/990,083

(22) Filed: Dec. 20, 2024

(51) Int. Cl. H04W 76/15; H04W 24/08; H04W 88/08

(52) U.S. Cl. CPC H04W 76/15; H04W 24/08; H04W 88/08

(57) ABSTRACT

In implementations of the present disclosure, there is provided an approach for an enhancement mechanism for fine time measurement. A method comprises detecting, by an access point (AP) multi-link device (MLD), a set of parameters for each of a plurality of links between the AP MLD and a set of station MLDs. Then, the AP MLD may use the set of parameters to determine a score for each of the plurality of links. The plurality of scores for the plurality of links may be used to select a set of links from the plurality of links for transmitting a plurality of FTM frames. The AP MLD further determines a number of the FTM frames to be transmitted on one of the set of links. Then, the AP MLD transmits the number of the FTM frames to the set of station MLDs via the one of the set of links.

### BACKGROUND

The fine time measurement (FTM) is also known as Wi-Fi round trip time (RTT). The purpose of FTM is to estimate a distance between an initiating station and a response station. For example, the round-trip time difference between the initiating station and the response station is calculated to figure out the distance. Compared with a received signal strength indicator (RSSI) based location feature, FTM is an upgrade or enhancement technology.

A multi-link operation (MLO) is one major medium access control (MAC) feature introduced in Wi-Fi 7. It enables devices to exchange frames over multiple links. MLO enables a station multi-link device (MLD) to discover, authenticate, associate, and set up multiple links with an access point (AP) MLD. Each link enables channel access and frame exchanges between the station MLD and the AP MLD based on the supported capability exchanged during association.

### BRIEF DESCRIPTION OF THE DRAWINGS

Implementations of the present disclosure may be understood from the following Detailed Description when read with the accompanying figures. In accordance with the standard practice in the industry, various features are not drawn to scale. In fact, the dimensions of the various features may be arbitrarily increased or reduced for clarity of discussion. Some examples of the present disclosure are described with respect to the following figures.

FIG. 1 illustrates a block diagram of an example environment in which reference implementations of the present disclosure may be implemented;

FIG. 2 illustrates an example of using one link to transmit FTM frames according to implementations of the present disclosure;

FIG. 3 illustrates an example of using a plurality of links to transmit FTM frames according to implementations of the present disclosure;

FIG. 4 illustrates an example of transmitting FTM frames on two links according to implementations of the present disclosure;

FIG. 5 illustrates an example of transmitting FTM frames in a restricted target wake time (R-TWT) service period (SP) according to implementations of the present disclosure;

FIG. 6 illustrates a flow chart of determining an overall measure error and a target total number of the FTM frames according to implementations of the present disclosure;

FIG. 7 illustrates a flow chart of an example method for controlling an AP MLD according to implementations of the present disclosure; and

FIG. 8 illustrates an example access point multi-link device according to implementations of the present disclosure.

### DETAILED DESCRIPTION

As discussed above, the FTM is used to estimate a distance between an initiating station and a response station. Since the FTM measurement process is time-sensitive, the unicast frame for the FTM needs to be transmitted multiple times between the initiating station and the response station in a short inter-frame space (SIFS) time period, which may be called an FTM burst. If the initiating station has multiple neighbors, it needs to communicate with each neighbor one by one. In this case, one problem is that the current working band/home channel band will be occupied during the FTM process, which introduces the self-traffic suspension and increases the time delay.

Moreover, achieving accurate FTM results requires multi-factors like large bandwidth, latest high-efficiency (HE)/enhanced high-throughput (EHT) standard and lower interference, etc. Another problem is that although the multiple FTM bursts would help on the accuracy improvement, they can also lead to stop BSS services periodically.

Furthermore, the multi-link operation (MLO) is one major media access control (MAC) feature introduced in WiFi-7, and the MLO enables a non-AP MLD to set up a plurality of links with an AP MLD. Each link of the plurality of links enables channel access and frames exchanges between the non-AP MLD and the AP MLD. However, there is no available guidance or widely adopted technology for leveraging the MLO feature with the FTM. Moreover, the above two problems become more complex in MLD cases.

Therefore, implementations of the present disclosure propose a solution for enhancing FTM for Wi-Fi 7 MLD. According to implementations of the present disclosure, the AP MLD may detect a set of parameters for each of a plurality of links between the AP MLD and a set of station MLDs. Then, the AP MLD may use the set of parameters to determine a score for each of the plurality of links. The plurality of scores for the plurality of links is used to select a set of links from the plurality of links for transmitting a plurality of FTM frames. Next, the AP MLD may further determine a number of the FTM frames to be transmitted on one of the set of links. Then, the AP MLD transmits the number of the FTM frames to the set of station MLDs via one of the set of links.

Therefore, the AP MLD can use the scores for the plurality of links to determine a set of links from the plurality of links, and distribute the plurality of FTM frames on the determined set of links. Therefore, one link is used to transmit the FTM frame while other links of the plurality of links may be used to transmit traffic between the AP MLD and the set of station MLDs. Thus, this method avoids the time delay and suspension for the traffic between the AP and the set of station MLDs while performing a FTM measurement process.

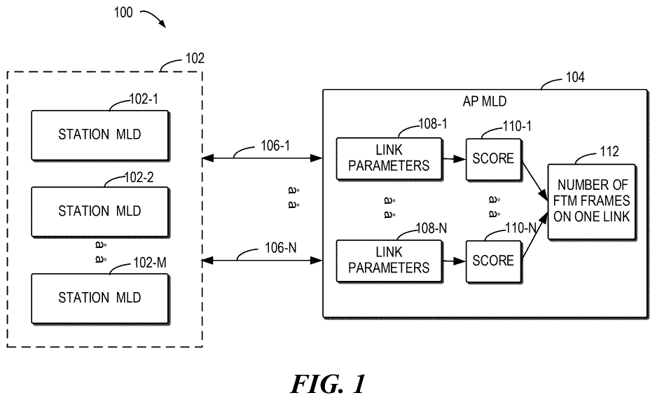

Other advantages of implementations of the present disclosure will be described with reference to the reference implementations as described below. Reference is made below to FIG. 1 through FIG. 8 to illustrate basic principles and several reference implementations of the present disclosure herein.

FIG. 1 shows a block diagram of an example environment in which reference implementations of the present disclosure may be implemented. In the example environment 100 of FIG. 1, an AP MLD 104 communicates with a set of station MLDs 102 over a plurality of links, for example, a link 106-1, . . . , a link 106-N, where N is an integer.

In one example, the plurality of links may be two links. For example, one link relates to 2.4 GHZ, and the other link relates to 5 GHZ. In another example, the plurality of links may be three links. For example, a first link relates to 2.4 GHZ, a second link relates to 5 GHZ, and a third link relates to 6 GHz. The above examples are only used to illustrate the disclosure, rather than a limitation to the disclosure.

The set of station MLDs 102 includes a station MLD 102-1, a station MLD 102-2, . . . , and a station MLD 102-M, where M is an integer. Each of the station MLD 102-1, the station MLD 102-2, . . . , and the station MLD 102-M may communicate with the AP MLD 104 through a part of the plurality of links or all of the plurality of links. For example, there are three links between the AP MLD 104 and the set of station MLD 102. The bands 2.4 GHZ, 5 GHZ, 6 GHz are used. The station MLD 102-1 may communicate with the AP MLD 104 via two links, such as the links for 2.4 GHz and 5 GHz. The station MLD 102-2 may communicate with the AP MLD 104 via three links.

In implementations of the present disclosure, for each link of the plurality of links, the AP MLD 104 may detect a set of parameters. For example, for the link 106-1, the AP MLD 104 may detect a set of link parameters 108-1; and for the link 106-N, the AP MLD 104 may detect a set of link parameters 108-N. Additionally, the detected parameters for each link are the same.

For example, the AP MLD 104 may detect a number of stations connected to the AP MLD 104 on each of the plurality of links. Moreover, the AP MLD 104 may detect channel utilization for each link of the plurality of links, which refers to a proportion of time that a communication channel is actually in use over a given period. Furthermore, the AP MLD 104 may further detect a traffic priority, station types, bandwidth, noise floor, a received signal strength indicator (RSSI), and/or a result feedback for a previous FTM. Therefore, the set of parameters for each link may include at least one of the number of stations, the channel utilization, the traffic priority, the station types, the bandwidth, the noise floor, the RSSI, and the result feedback for a previous FTM to calculate a score for a link. The above description is only used to illustrate the disclosure, rather than the limitation to the disclosure. The set of parameters may include any suitable parameters.

After obtaining the set of parameters for each of a plurality of links, the AP MLD 104 may use the set of parameters to calculate a score for the link to evaluate a quality of the link. For example, the set of parameters 108-1 for the link 106-1 may be used to calculate a score 110-1 for the link 106-1; the set of parameters 108-N for the link 106-N may be used to calculate a score 110-N for the link 106-N. In one example, the AP MLD 104 uses the number of stations, the channel utilization, the bandwidth, the noise floor, the RSSI, and the result feedback for a previous FTM on link 106-1 to calculate a score for the link 106-1.

Then, the AP may determine a set of links from the plurality of links based on the scores for the plurality of links. In one example, the AP MLD 104 may select one link from the plurality of links based on the scores. The selected link is used to transmit a plurality of FTM frames between the AP MLD 104 and the set of station MLD 102. In another example, the AP MLD104 may select the multiple links with scores which are greater than a threshold score. The selected multiple links are used to transmit a plurality of FTM frames between the AP MLD 104 and the set of station MLD 102. Additionally, or alternatively, the plurality of links which have scores are selected or determined to transmit a plurality of FTM frames between the AP MLD 104 and the set of station MLD 102.

Moreover, the AP MLD 104 further needs to determine a number of the FTM frames 112 to be transmitted on one link of the set of links. For example, if the link 106-1 is selected to transmit the FTM frames, the AP MLD 104 further determines the number of the FTM frames to be transmitted on the link 106-1. The AP MLD 104 may determine the number of the FTM frames to be transmitted on one link based on the score for the link. For example, if the scores for the plurality of links are used to select only one link to transmit the FTM frames, the number of the FTM frames transmitted on the selected one link is the total number of the plurality of FTM frames. If all of the plurality of links are used to transmit the FTM frames, the scores are used to assign FTM frames across the plurality of links. For example, if the score for one link is higher, the more FTM frames would be assigned to the link; and if the score for one link is lower, the less FTM frames would be assigned to the link.

Then, the determined set of links is used by the AP MLD 104 to transmit the plurality of FTM frames. Through transmitting the FTM frames, the AP MLD 104 may perform FTM measurements. These FTM measurements may be used to estimate the distance between the AP MLD 104 and the target station receiving the FTM frames. By performing serval FTM measurements, the distance may be calculated accurately.

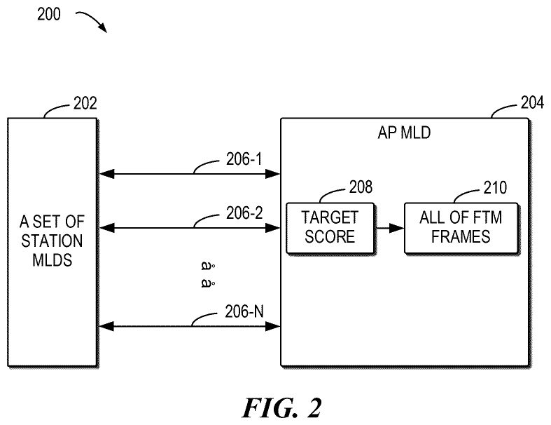

FIG. 2 shows an example 200 of using one link to transmit FTM frames according to implementations of the present disclosure. In the example 200, a set of station MLDs 202 communicates with the AP MLD 204 via a plurality of links, including, a link 206-1, a link 206-2, . . . , and a link 206-N. For the plurality of links, the AP MLD 204 may obtain link parameters for each link of the plurality of links. Then, the AP MLD 204 uses the obtained link parameters to calculate a score for each link, thereby the AP MLD 204 may obtain a plurality of scores for the plurality of links.

In some implementations, the AP MLD 204 may use an algorithm to calculate a score for each of the plurality of links. In this algorithm, a number of stations, the station types (MLD or non-MLD), a number of bands supported, traffic priority, and channel utilization are used to calculate a score for one link. Therefore, according the algorithm, the plurality of scores for the plurality links are obtained. Then, a target score 208 is selected from the plurality of scores. For example, the target score is the highest score. Therefore, the best link with the highest score is selected from the plurality of links to transmit all of FTM frames 210 between the AP MLD 204 and the set of station MLDs 202 to do FTM measurement, for example performing FTM scans for specific FTM-capable neighbor devices.

Alternatively, one configuration knob may be introduced as “MLD FTM auto”. When this knob is enabled and the FTM scan is enabled on multiple radios, the AP MLD 204 will pick the best link of the plurality of links to do FTM scan, avoid affecting the station traffic on other links between the AP MLD 204 and the set of station MLDs 202 at the same time.

In some implementations, the AP MLD 204 may use the following equation (1) to calculate a score for each link of the plurality of links:

$${Δ}_{weight} = f ( channel utility , bandwidth , NF , RSSI , {Feedback}_{l i n k - i} , … ) \qquad ( 1 )$$

wherein Δ_{weight} represents a score or standard for a link, f( ) represents a function which used to calculate a score; NF represents noise floor, RSSI represents a received signal strength indicator, Feedbackₗᵢₙₖ₋ᵢ represents a link; FTM result feedback. Therefore, for the plurality of links, the AP MLD 204 may obtain a plurality of scores. In one example, the AP MLD 204 determines a highest score from the plurality of scores as the target score 208 and selects the link with the highest score from the plurality of links. Then, the selected link is used to transmit all of FTM frames 210 between the AP MLD 204 and the set of station MLDs. In another example, the AP MLD 204 may determine a lowest score from the plurality of scores as a target score and select the link with the lowest score from the plurality of links. Therefore, the link with the lowest score is used to transmit all of FTM frames 210.

As described above, the target link or the selected link is used to transmit all of FTM frames 210 between the AP MLD 204 and the set of station MLDs. Because only one link is used to transmit the FTM frames, the other links of the plurality of links would not be used to transmit the FTM frames. In this case, the other links are still used to serve the traffic between the AP MLD 204 and the set of station MLDs 202. In this case, when one radio is doing an FTM scan, the AP MLD 204 will forbid other radios to do an FTM scan, so it can allow station MLDs to keep the data traffic with the lowest interruption.

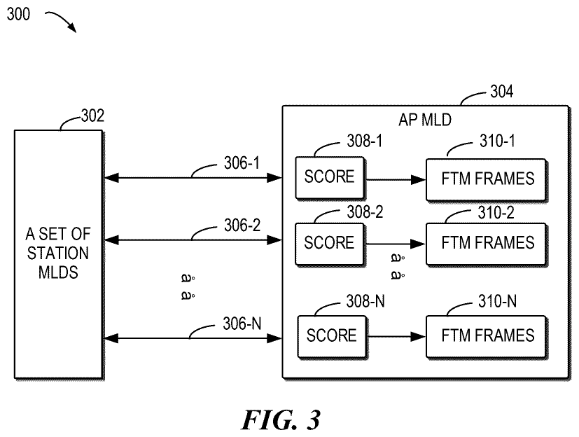

As described above, FIG. 2 shows an example of transmitting FTM frames by using one link. Another example for transmitting FTM frames is introduced with reference to FIG. 3. FIG. 3 shows examples 300 of using a plurality of links to transmit FTM frames according to implementations of the present disclosure.

In example 300, the AP MLD 304 and a set of station MLDs 302 communicate with each other via a plurality of links, including a link 306-1, 306-2, . . . 306-N. The AP MLD 304 may calculate a plurality of scores for the plurality of links and each link has a corresponding score. The score may be calculated with reference to the content described in FIG. 2. For example, the AP MLD 304 may determine a score 308-1 for the link 306-1, determine a score 308-2 for the link 306-2, . . . , and determine a score 308-N for the link 306-N. Then, the AP MLD 304 may use the plurality of scores to determine how many FTM frames need to be transmitted on each of the plurality of links. For example, the AP MLD 304 determines the FTM frames 310-1 transmitted on the link 306-1 based on the score 308-1. The AP MLD 304 determines the FTM frames 310-2 transmitted on the link 306-2 based on the score 308-2 and determines the FTM frames 310-N transmitted on the link 306-N based on the score 308-N,

Moreover, the AP MLD 304 may obtain the total number of a plurality of FTM frames between the AP MLD 304 and the set of station MLDs 302. The total number of the plurality of FTM frames equals a number of total bursts. The number of total bursts is calculated by using the following equation (2):

$${N}_{total burst} = {N}_{clients} \cdot {M}_{each client burst number} \qquad ( 2 )$$

where N_{clients} represents a total number of stations, and M_{each client burst number} represents a number of FTM exchange times each station needs to do.

After determining the total number of a plurality of FTM frames, the AP MLD 304 may further distribute the plurality of FTM frames on the plurality of links according the plurality of scores.

For example, the number of total bursts also may be calculated by using the following equation (3):

$${N}_{total burst} = {\sum }_{i = 1}^{n} ( {Δ}_{weight - i} \cdot {link}_{i} ) \qquad ( 3 )$$

wherein Δ_{weight-i} represents a score for linkᵢ, n represents the number of the plurality of links; link; represent the i-th link. The value of linkᵢ may be 1 in the above equation (3). Therefore, a number of FTM frames for one unit of a score Burstₘᵢₙ may be calculated with the following equation (4):

$${Burst}_{min} = {N}_{total burst} / {\sum }_{i = 1}^{n} ( {Δ}_{weight - i} ) \qquad ( 4 )$$

After the Burstₘᵢₙ is determined, the FTM frame to be transmitted on the linkᵢ may be calculated by multiplying the Burstₘᵢₙ by Δ_{weight-i}.

In some implementations, the AP MLD 304 may calculate a ratio about the plurality of scores. Then the AP MLD 304 uses the ratio items as the corresponding scores. Therefore, each of the plurality of links has a corresponding ratio item. Then, the AP MLD 304 may determine a number of the FTM frames to be transmitted on each of the set of links based on the total number and the ratio. For example, the number of set of station MLDs is 8, and the Burst size is 8, then N_{total burst}=64. Assume there are three MLD links and after calculation, the ratio of Δ_{weight} for a three links was 4:3:1, then Burstₘᵢₙ will be 8. Then the final FTM burst number assigned to each link will be Link-1:32, Link-2:24, Link-3:8.

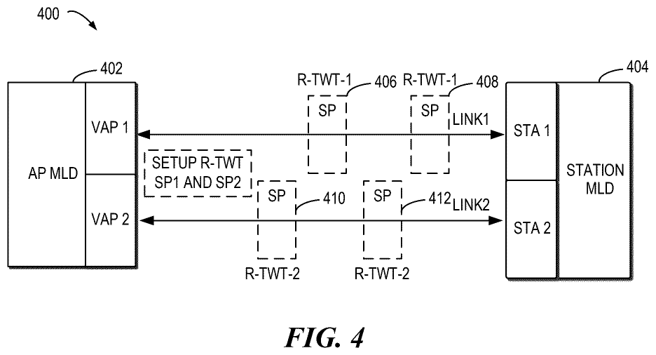

As described above, the plurality of TWT frames may be distributed across the plurality of links. In this case, the plurality of links may be used to transmit the plurality of FTM frames. The TWT feature (individual/broadcast/restricted TWT) may be leveraged to protect the FTM process to let each MLD link FTM burst more accurately and improve the efficiency. FIG. 4 illustrates an example 400 of transmitting FTM frames on two links according to implementations of the present disclosure. In the example 400, R-TWT is used as an example. An AP MLD 402 has two virtual access points (VAPs), VAP 1 and VAP 2, and a station MLD 404 has two stations, STA 1 and STA 2. There are two links (link 1 and link 2) between the AP MLD 402 and the station MLD 404.

The link 1 is used to communicate traffic between the VAP 1 and the STA 1, and the link 2 is used to communicate traffic between the VAP 2 and the STA 2. The AP MLD 402 and the station MLD 404 will establish R-TWT session between link-1 and link-2. For example, there are two service periods (SP) for R-TWT-1 on link 1, the SP 406 and SP 408. The SP 406 and SP 408 are used to transmit FTW frames assigned to the link 1. On link 2, there are two SPs for R-TWT-2, the SP 410 and SP 412. The SP 410 and SP 412 are used to transmit FTW frames assigned to the link 2. As shown in FIG. 4, this session was staggered in time. For example, the SP 406 on the link 1 is used at different time periods from the SP 410 and 412 on the link 2. The SP 408 on the link 1 is used at different time periods from the SP 410 and 412 on the link 2. At the same time, the SP 410 and the SP 412 on link 2 are also different from the SP 406 and SP 408 on link 1 in time. This method may make sure that one MLD link can serve clients when performing FTM frame exchanges on the other link.

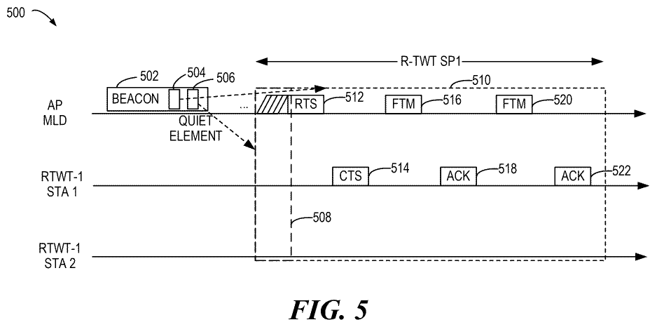

FIG. 5 illustrates some examples of an example of transmitting FTM frames in an R-TWT SP according to implementations of the present disclosure. In the example 500, during an R-TWT scheduling process, the AP MLD will send a beacon 502 to STA 1 and STA2. The beacon includes at least two information elements (IEs), which are an R-TWT IE 504 and a quiet IE 506. The R-TWT IE 504 includes the starting time of the R-TWT SP 510. The quiet IE includes a starting time of quiet interval 508. The starting time of the R-TWT SP 510 is the same as the starting time of quiet interval 508. Therefore, the quiet IE is used to protest the R-TWT SP start time, this character may try its best to guarantee the FTM exchange frame without other interference and make the result more accurate.

Next, the AP MLD transmits a request to send (RTS) frame 512 to the STA 1. The RTS frame contains information such as the time required for data transmission. After the STA 1 receives the RTS frame 512, it will send a clear to send (CTS) frame 514 to the AP MLD. After receiving the CTS frame 514, the AP MLD determines that it can start sending data. Then, the AP MLD transmits an FTM frame 516 to the STA 1 on the link 1. The STA 1 accepts the FTM frame 516, generates an acknowledgment (ACK) frame 518 for the FTM frame 516, and sends the ACK frame 518 to the AP MLD. Next, the AP MLD may continue to transmit another FTM frame 520 to the STA 1 and after the FTM frame 520 is received by the STA 1, the STA 1 continues to send an ACK frame 522 to the AP MLD. During this process, the communication between the AM MLD and STA 2 on the same link is prohibited. FIG. 5 shows that two FTM frames are sent to the STA 1 in one R-TWT SP 1. It is an example to illustrate the disclosure, rather than the limitation to the disclosure. In some implementations, more FTM frames or one FTM frame are transmitted in one R-TWT SP. Moreover, for the individual/broadcast TWT, the situation is the same as the R-TWT.

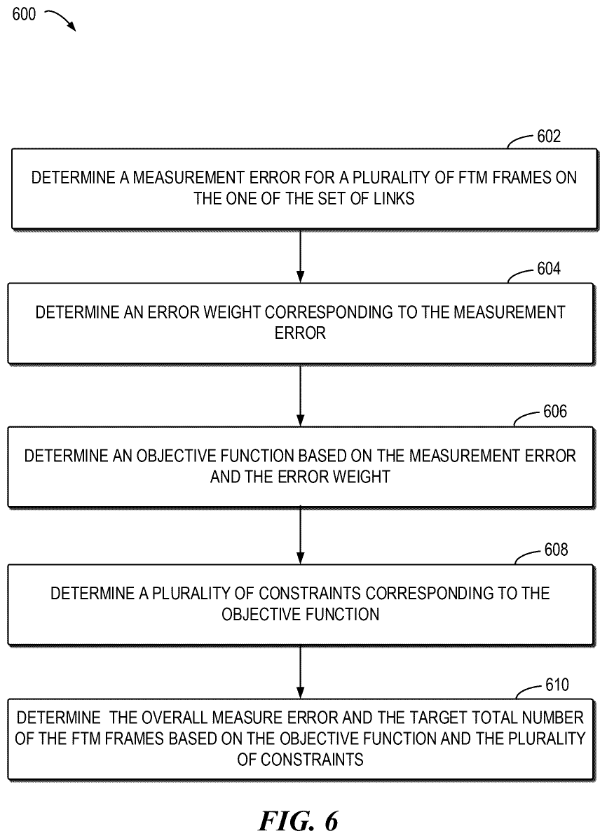

After the FTM frames are transmitted across the plurality of links, the FTM measures are collaborated on the plurality of links to reduce the overall measurement error, thereby improving the overall accuracy result. In this case, a small burst N (a measurement count) is determined while the overall error E remains below a certain threshold. This process will be described with reference to FIG. 6. FIG. 6 illustrates a flow chart of determining an overall measure error and a target total number of the FTM frames according to implementations of the present disclosure.

In the method 600, at block 602, the AP MLD 104 determines a measurement error for a plurality of FTM frames on the one of the set of links. When the AP MLD 104 sends an FTM frame to a station MLD, an FTM measurement result would be obtained. The AP MLD 104 may further calculate the measurement error for a plurality of FTM frames by using the FTM measurement result.

For example, there is a plurality of links between the AP MLD 104 and the set of station MLDs 102 to transmit the FTM frames. The number of the plurality of links is n. Then, the measurement error obtained on link i (1≤i≤n) is denoted as eᵢ for the FTM measure times Nᵢ. The error eᵢ for the FTM measure times Nᵢ may be an average error e_{i,avg}, which is the average value for the n measurements. For each measurement, the AP MLD may obtain an error value. These error values for the FTM measure times Nᵢ. may be used to calculate the measurement error eᵢ.

In some implementations, the error value for each measurement may be calculated by using neighbor AP with static location. In some implementations, Bluetooth Low Energy (BLE) technology or a global positioning system (GPS) technology may be used to calculate the reference location. Then, the error value for each measurement is calculated by comparing the measurement location and the reference location.

At block 604, the AP MLD 104 determines an error weight corresponding to the measurement error. After the AP MLD 104 determines the measurement error for the plurality of measurements on the link, an error weight corresponding to the measurement may be calculated. The error weight corresponding to the measurement error may be determined by using some parameters for the link. For example, the parameters may include at least one of a throughput priority, channel utilization, noise floor, physical layer (PHY) and media access control layer (MAC) capability, a number of stations, and a result feedback for a previous FTM measurement.

For example, for the measurement error et on link i, the corresponding weight is wᵢ which may be calculated by using the following equation (5).

$$w = {f}_{w} ( {TP}_{p riority} , c h a {n}_{util} , NF , {PHY\_MAC}_{capibility} , {client}_{n u m} , etc . ) \qquad ( 5 )$$

where, TP_{priority}, represents a throughput priority, chanᵤₜᵢₗ represents channel utilization, NF represents noise floor, PHY_MAC_{capibility} represents physical layer and media access control layer capability, clientₙᵤₘ represents a number of stations. Additionally, the input parameters may further include a result feedback for a previous FTM measurement. In some implementation, the function used to calculate the corresponding weight may be the function used to calculate the above score to simply calculate.

At block 606, the AP MLD 104 determines an objective function based on the measurement error and the error weight. In order to obtain a small burst N and proper overall error E, an objective function is used to achieve the above requirement. The object function may use the measurement error and the error weight as parameters.

For example, the objective function may be represented as the weighted sum of squared errors for each link. The objective function (6) is shown as below:

$${min}_{{w}_{i} , {N}_{i}} ( {\sum }_{i = 0}^{n} {( {w}_{i} \cdot {e}_{i} )}^{2} ) \qquad ( 6 )$$

In this objective function, the error weight wᵢ and the measure counter Nᵢ for link I may be tuned to minimize the impact of the error on each link on the overall error E as much as possible.

At block 608, the AP MLD 104 determines a plurality of constraints corresponding to the objective function. For the objective function, in order to obtain optimal results, it is required to set some constraints. The constraints may ensure the objective function to produce the best result.

For example, for the above objective function (6), the constraints (7), (8), (9), and (10) are shown below.

$$E = {\sum }_{i = 1}^{n} {w}_{i} \cdot {e}_{i} \leq {Threshold}_{E} \qquad ( 7 )$$

$$N = {\sum }_{i}^{n} {N}_{i} \leq {Threshold}_{N} \qquad ( 8 )$$

$$max {N}_{i} \leq {Threshold}_{N \_ MAX} \qquad ( 9 )$$

$${N}_{i} \leq {Threshold}_{N \_ link \_i} \qquad ( 10 )$$

The above constraints ensure that the overall error E does not exceed a certain threshold Threshold_{E} and the measurement count N for the plurality of link is limited the Threshold_{N} to minimize resource consumption or maximize efficiency. Threshold_{N} is the value, which may be the example value 64 (total FTM burst number, other threshold can also be predefined) that is mentioned in the above examples. FTM measurements on specific link or overall links should be finished in a certain time, it means the max/each of Nᵢ dose not exceed a certain value.

In some implementations, If the affiliated AP of AP/STA MLD PHY/MAC condition is similar, wᵢ, eᵢ, Nᵢ is the same on all links. Therefore, the overall FTM measurement error can be represented as the average of the measurement errors on each link, and it needs to re-use single link/band FTM optimization method. For example,

$$E = \frac{1}{n} {\sum }_{i = 1}^{n} {e}_{i} = {e}_{i} and {N}_{i} = \frac{N}{n} .$$

At block 610, the AP MLD 104 determines the overall measure error and the target total number of the FTM frames based on the objective function and the plurality of constraints. The AP MLD 104 may utilize the above the objective function and the plurality of constraints to calculate the best overall measure error and the best number of the FTM frames by attempting different measure errors and the number of the FTM frames.

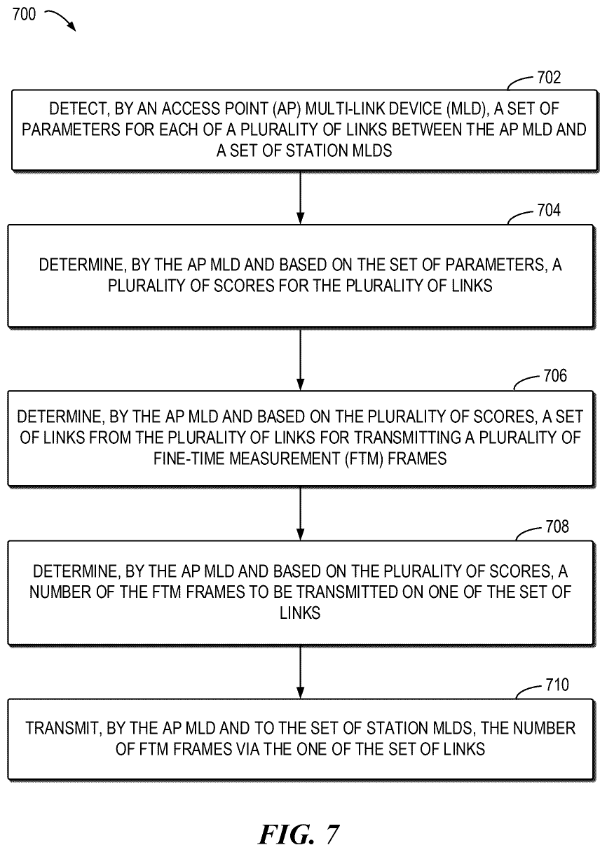

FIG. 7 illustrates a flow chart of an example method for controlling an AP MLD according to implementations of the present disclosure, and the method 700 is performed by an AP MLD. At 702, the AP MLD detects a set of parameters for each of a plurality of links between the AP MLD and a set of station MLDs. For example, the AP MLD may perform measurement on the plurality of links and obtain the parameters for each of the plurality of links. For example, the AP MLD may detect channel utilization by transmitting some frames on one link. Moreover, the AP MLD may further obtain a number of stations connected to the AP MLD via each link. For example, the AP MLD records all of the stations connected to it in the information table in the AP MLD, including the links through which the stations are connected to the AP MLD.

At 704, the AP MLD determines, based on the set of parameters, a plurality of scores for the plurality of links. For example, when the AP MLD obtains a set of parameters for each of the plurality of links, the AP MLD may calculate a score for the link by inputting the set of parameters of the link into a function. Therefore, the AP MLD will generate a plurality of scores for the plurality of links. The score for one link may be used to indicate the link quality.

At 706, the AP MLD determines, based on the plurality of scores, a set of links from the plurality of links for transmitting a plurality of fine-time measurement (FTM) frames. For example, after the AP MLD obtains the plurality of scores, the AP MLD will select a set of links which are used to transmit the FTM frame to perform FTM measurements. During this process, the AP MLD uses the scores of the plurality of links to select the set of links.

In some implementations, the AP MLD selects one link from the plurality of links for transmitting all of the FTM frames between the AP MLD and the set of station MLDs. The selected one link may have the highest score or the lowest score, which is determined based on the requirement. In some implementations, the APMLD may select a set of links from the plurality of links. Each of the selected set of links has a score which is greater than a threshold score. In this case, a part of the plurality of links is used to transmit all of the FTM frames between the AP MLD and the set of station MLDs.

In some implementations, the AP MLD may select the plurality of links as the set of links. If a link has a score, it shows that the link is available. Therefore, the plurality of links with the plurality of scores may be used to transmit the FTM frames between the AP MLD and the set of station MLDs. Therefore, in this case, all of the plurality of links are used to transmit FTM frames.

At 708, the AP MLD determines, based on the plurality of scores, a number of the FTM frames to be transmitted on one of the set of links. Because the AP MLD obtains a score for each of the plurality of links, the score for the link may be used to determine the number of the FTM frames transmitted by this link. For example, when one link is selected based on the plurality of scores to transmit the FTM frames, the number of the FTM frames to be transmitted on this link is the total number of the FTM frames. When the plurality of FTM frames is transmitted across the plurality of links, the AP MLD may determine a number of the FTM frames transmitted on one link based on the score for the link. For example, the AP MLD may determine a ratio of the plurality of scores, then the AP MLD may determine a number of the FTM frames transmitted on the link based on the ratio item.

At 710, the AP MLD transmits, to the set of station MLDs, the number of FTM frames via the one of the set of links. After the number of the FTM frames transmitted on one link is determined, the AP MLD may send the number of the FTM frames according to the requirement. For example, when the AP MLD transmits the FTM frames on one link, the other links of the plurality of links would not transmit FTM frames. The period for transmitting the FTM frames on one link of the plurality of links is different from a period for transmitting the FTM frame on another link of the plurality of links.

In some implementations, the AP MLD may further detect the measure results for the FTM frames transmitted on each link. The errors for the measure results are further used to determine a best measure times and a suitable overall error for all of the links.

In this way, the AP MLD may use some links of the plurality of links to transmit FTM frames while using other links of the plurality of links to transmit traffic frames. This may avoid the time delay and suspension of the traffic between the AP and the set of station MLDS.

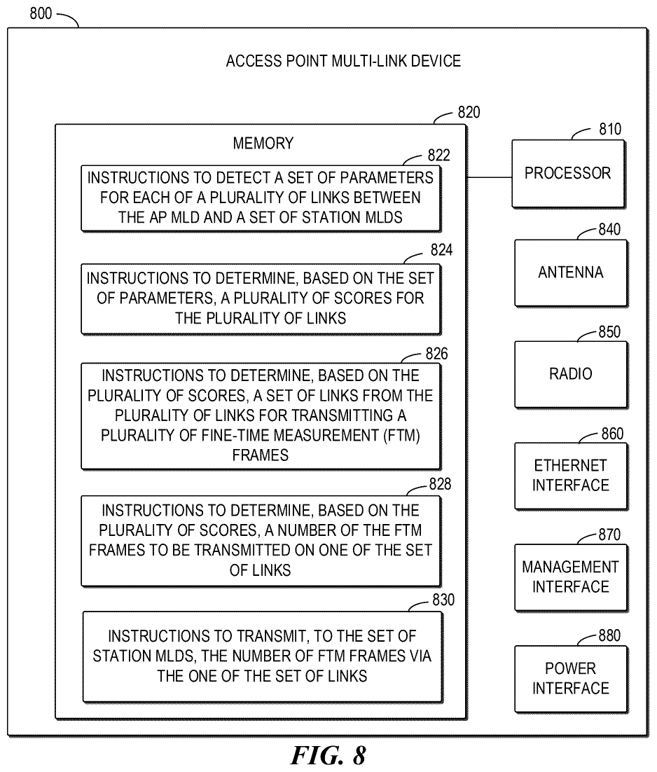

FIG. 8 illustrates an example AP MLD 800 according to implementations of the present disclosure. As shown in FIG. 8, the AP MLD 800 comprises at least one processor 810, a memory 820 coupled to the processor 810, at least one antenna 840, at least one radio 850, an Ethernet interface 860, a management interface 870, and a power interface 880. The memory 820 stores instructions 822, 824, 826, 828, and 830 to cause the processor 810 to perform actions according to reference implementations of the present disclosure.

As shown in FIG. 8, the memory 820 stores instructions 822 to detect a set of parameters for each of a plurality of links between the AP MLD and a set of station MLDs. The memory 820 further stores instructions 824 to determine, based on the set of parameters, a plurality of scores for the plurality of links. Moreover, the memory 820 further stores instructions 826 to determine, based on the plurality of scores, a set of links from the plurality of links for transmitting a plurality of fine-time measurement (FTM) frames. The memory 820 further stores instructions 828 to determine, based on the plurality of scores, a number of the FTM frames to be transmitted on one of the set of links. As shown in FIG. 8, the memory 820 further stores instructions 830 to transmit, to the set of station MLDs, the number of FTM frames via the one of the set of links.

The stored instructions and the functions that the instructions may perform can be understood with reference to implementations as described above. For brevity, the details of instructions 822, 824, 826, 828, and 830 will not be discussed herein.

The at least one antenna 840 in the AP MLD 800 is a crucial component that allows the AP MLD 800 to communicate with wireless devices such as laptops, smartphones, and tablets. The primary function of the at least one antenna 840 may be to transmit and receive wireless signals, converting electrical signals into radio waves for outgoing communication and vice versa for incoming signals.

The at least one radio 850 in the AP MLD 800 is responsible for wireless communication. The at least one radio 850 may handle the conversion of data between wired and wireless forms, making it possible for the AP MLD 800 to transmit and receive data over the air. In a modulation process, the digital data from the wired network may be converted into radio waves for wireless transmission. In a demodulation process, incoming radio waves may be converted back into digital data that the AP MLD 800 can process. The at least one radio 850 may operate on specific frequency bands, such as 2.4 GHZ, 5 GHZ, or 6 GHz bands. The at least one radio 850 may ensure effective communication by selecting appropriate channels to minimize interference. The performance of the at least one radio 850 may be defined by various Wi-Fi standards, including 802.11a/b/g/n/ac/ax, with newer standards like Wi-Fi 6 and Wi-Fi 7 offering improved speed, efficiency, and capacity.

The Ethernet interface 860 in the AP MLD 800 may be used for connecting the AP MLD 800 to the local network, providing a bridge between the wired and wireless segments of the network. The AP MLD 800 may connect to routers, switches, or directly to the internet through the Ethernet interface 860, enabling the wireless devices to communicate with other network resources and the broader internet. The Ethernet interface may support various speeds, including Fast Ethernet (e.g., 100 Mbps), Gigabit Ethernet (e.g., 1 Gbps), and even Multi-Gigabit Ethernet.

The management interface 870 in the AP MLD 800 may allow network administrators to configure, monitor, and manage the settings and performance of the AP MLD 800. The management interface 870 may be accessed through various methods, such as a web browser, command line interface (CLI), or network management protocols like Simple Network Management Protocol (SNMP). Through the management interface 870, the administrators can set up and modify SSIDs, security protocols, VLANs, and other operational parameters, ensuring the AP 800 operates effectively within the network environment.

The power interface 880 in the AP MLD 800 may supply the necessary electrical power to the device, ensuring that the AP MLD 800 may operate smoothly and effectively. This can be achieved through a direct power supply using an AC adapter connected to a power outlet, or via Power over Ethernet (POE), which delivers power through the same Ethernet cable used for data transmission.

Program codes or instructions for carrying out methods of the present disclosure may be written in any combination of one or more programming languages. These program codes or instructions may be provided to a processor or controller of a general-purpose computer, special-purpose computer, or other programmable data processing apparatus, such that the program codes when executed by the processor or controller, cause the functions/operations specified in the flowcharts and/or block diagrams to be implemented. The program code or instructions may execute entirely on a machine, partly on the machine, as a stand-alone software package, partly on the machine and partly on a remote machine, or entirely on the remote machine or server.

Program codes or instructions for carrying out methods of the present disclosure may be written in any combination of one or more programming languages. These program codes or instructions may be provided to a processor or controller of a general-purpose computer, special-purpose computer, or other programmable data processing apparatus, such that the program codes, when executed by the processor or controller, cause the functions/operations specified in the flowcharts and/or block diagrams to be implemented. The program code or instructions may execute entirely on a machine, partly on the machine, as a stand-alone software package, partly on the machine and partly on a remote machine, or entirely on the remote machine or server.

In the context of this disclosure, a machine-readable medium may be any tangible medium that may contain or store a program for use by or in connection with an instruction execution system, apparatus, or device. The machine-readable medium may be a machine-readable signal medium or a machine-readable storage medium. A machine-readable medium may include but is not limited to an electronic, magnetic, optical, electromagnetic, infrared, or semiconductor system, apparatus, device, or any suitable combination of the foregoing. More specific examples of the machine-readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order or that all illustrated operations be performed to achieve desirable results. In certain circumstances, multitasking and parallel processing may be advantageous. Certain features that are described in the context of separate implementations may also be implemented in combination in a single implementation. Conversely, various features that are described in the context of a single implementation may also be implemented in multiple implementations separately or in any suitable sub-combination.

In the foregoing Detailed Description of the present disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the present disclosure.

What is claimed:

1. A method comprising:
detecting, by an access point (AP) multi-link device (MLD), a set of parameters for each of a plurality of links between the AP MLD and a set of station MLDs,
determining, by the AP MLD and based on the set of parameters, a plurality of scores for the plurality of links;
determining, by the AP MLD and based on the plurality of scores, a set of links from the plurality of links for transmitting a plurality of fine-time measurement (FTM) frames;
determining, by the AP MLD and based on the plurality of scores, a number of the FTM frames to be transmitted on one of the set of links; and
transmitting, by the AP MLD and to the set of station MLDs, the number of FTM frames via the one of the set of links.

2. The method according to claim 1, wherein the set of parameters comprises at least one of a number of stations, channel utilization, station types, a traffic priority, bandwidth, noise floor, a received signal strength indicator (RSSI), a result feedback for a previous FTM measurement.

3. The method according to claim 1, wherein the determining a set of links from the plurality of links for transmitting a plurality of fine-time measurement (FTM) frames comprises:
determining a highest score from the plurality of scores for the plurality of links; and
determining a link of the plurality of links corresponding to the highest score as the set of links.

4. The method according to claim 1, wherein the set of links comprises the plurality of links, and the determining a number of the FTM frames to be transmitted on one of the set of links comprises:
determining a total number of the plurality of FTM frames to be transmitted between the AP MLD and the set of station MLDs; and
determining the number of the FTM frames to be transmitted on each of the plurality of links based on the total number and the plurality of scores.

5. The method according to claim 4, wherein the determining a total number of the plurality of fine-time measurement (FTM) frames to be transmitted between the AP MLD and a set of station MLDs comprises:
determining a first number of the set of station MLDs;
determining a second number of FTM exchange times for each of the set of station MLDs; and
determining the total number of the plurality of FTM frames based on the first number and the second number.

6. The method according to claim 4, wherein determining the number of the FTM frames to be transmitted on each of the set of links based on the total number and the plurality of scores comprises:
determining a ratio for the plurality of scores; and
determining the number of the FTM frames to be transmitted on each of the set of links based on the total number and the ratio.

7. The method according to claim 4, wherein transmitting the number of FTM frames via the one of the set of links comprises:
determining a set of FTM frames from the number of FTM frames; and
transmitting the set of FTM frames via the one of the set of links during a target wake time (TWT) service period (SP), the TWT SP being staggered in time with a TWT SP on another link of the set of links.

8. The method according to claim 7, wherein transmitting the set of FTM frames via the one of the set of links during a target wake time (TWT) service period (SP) comprises:
transmitting the set of FTM frames to a first station MLD of the set of station MLDs via the one of the set of links during the TWT SP; and
preventing data communication between the AP MLD and other station MLDs of the set of station MLDs via the one of the set of links during the TWT SP.

9. The method according to claim 8, wherein the TWT SP is one of an individual TWT SP, a broadcast TWT SP, or a restricted TWT SP.

10. The method according to claim 1, further comprising:
determining a measurement error for a plurality of FTM frames on the one of the set of links; and
determining an error weight corresponding to the measurement error; and
determining an overall measure error and a target total number of the FTM frames on the set of links based on the measurement error and the error weight.

11. The method according to claim 10, wherein determining an error weight corresponding to the measurement error comprises:
determining the error weight corresponding to the measurement error based on at least one of a throughput priority, channel utilization, noise floor, physical layer (PHY) and media access control layer (MAC) capability, a number of stations, a result feedback for a previous FTM measurement.

12. The method according to claim 10, wherein determining an overall measure error and a target total number of the FTM frames on the set of links based on the measurement error and the error weight comprises:
determining an objective function based on the measurement error and the error weight;
determining a plurality of constraints corresponding to the objective function; and
determining the overall measure error and the target total number of the FTM frames based on the objective function and the plurality of constraints.

13. An access point (AP) multi-link device (MLD) comprising:
at least one processor;
a memory coupled to the at least one processor, the memory storing instructions to cause the at least one processor to:
detect a set of parameters for each of a plurality of links between the AP MLD and a set of station MLDs,
determine, based on the set of parameters, a plurality of scores for the plurality of links;
determine, based on the plurality of scores, a set of links from the plurality of links for transmitting a plurality of fine-time measurement (FTM) frames;
determine, based on the plurality of scores, a number of the FTM frames to be transmitted on one of the set of links; and
transmit, to the set of station MLDs, the number of FTM frames via the one of the set of links.

14. The AP MLD according to claim 13, wherein the set of parameters comprises at least one of a number of clients, channel utilization, station types, a traffic priority, bandwidth, noise floor, a received signal strength indicator (RSSI), a result feedback for a previous FTM.

15. The AP MLD according to claim 13, wherein the instructions to determine a set of links from the plurality of links for transmitting a plurality of fine-time measurement (FTM) frames comprise instructions to cause at least one processor to:
determine a highest score from the plurality of scores for the plurality of links; and
determine a link of the plurality of links corresponding to the highest score as the set of links.

16. The AP MLD according to claim 13, wherein the set of links comprises the plurality of links, and the instructions to determine a number of the FTM frames to be transmitted on one of the set of links comprise instructions to cause at least one processor to:
determine a total number of the plurality of FTM frames to be transmitted between the AP MLD and the set of station MLDs; and
determine the number of the FTM frames to be transmitted on each of the plurality of links based on the total number and the plurality of scores.

17. The AP MLD according to claim 16, wherein the instructions to determine a total number of the plurality of fine-time measurement (FTM) frames to be transmitted between the AP MLD and a set of station MLDs comprise instructions to cause at least one processor to:
determine a first number of the set of station MLDs;
determine a second number of FTM exchange times for each of the set of station MLDs; and
determine the total number of the plurality of FTM frames based on the first number and the second number.

18. The AP MLD according to claim 16, wherein the instructions to determine the number of the FTM frames to be transmitted on each of the set of links based on the total number and the plurality of scores comprise instructions to cause at least one processor to:
determine a ratio for the plurality of scores; and
determine the number of the FTM frames to be transmitted on each of the set of links based on the total number and the ratio.

19. The AP MLD according to claim 16, wherein the instructions to transmit the number of FTM frames via the one of the set of links comprise instructions to cause at least one processor to:
determine a set of FTM frames from the number of FTM frames; and
transmit the set of FTM frames via the one of the set of links during a target wake time (TWT) service period (SP), the TWT SP being staggered in time with a TWT SP on another link of the set of links.

20. A non-transitory computer-readable medium comprising instructions stored thereon which, when executed by an access point (AP) multi-link device (MLD), cause the AP MLD to:
detect a set of parameters for each of a plurality of links between the AP MLD and a set of station MLDs,
determine, based on the set of parameters, a plurality of scores for the plurality of links;
determine, based on the plurality of scores, a set of links from the plurality of links for transmitting a plurality of fine-time measurement (FTM) frames;
determine, based on the plurality of scores, a number of the FTM frames to be transmitted on one of the set of links; and
transmit, to the set of station MLDs, the number of FTM frames via the one of the set of links.
